(19) United States
(12) Patent Application Publication
(10) Pub. No.: US 2026/0031604 A1
(43) Pub. Date: Jan. 29, 2026

(54) ELECTRICAL CONNECTION UNIT

(71) Applicant: Yazaki Corporation, Tokyo (JP)

(72) Inventors: Kazuki KOBAYASHI, Kakegawa-shi (JP); Naoki Sakaguchi, Kakegawa-shi (JP); Shinya Oishi, Kakegawa-shi (JP); Toshitaka Iwasaki, Kakegawa-shi (JP)

(73) Assignee: Yazaki Corporation, Tokyo (JP)

(21) Appl. No.: 19/273,327

(22) Filed: Jul. 18, 2025

(30) Foreign Application Priority Data
Jul. 23, 2024 (JP) 2024-117486

(51) Int. Cl. H02G 3/14; H01R 13/447; H01R 13/506

(52) U.S. Cl. CPC H02G 3/14; H01R 13/447; H01R 13/506

(57) ABSTRACT

An electrical connection unit includes: an enclosure having a surface and an opening that is open on the surface; a rising structure that rises from the surface; and a cover capable of opening and closing the opening, wherein the enclosure includes a rib extending in an extending direction from the rising structure toward the opening, and the cover includes a protrusion pressed by the rib when the cover is opened.

### BACKGROUND OF THE INVENTION

### Field of the Invention

Embodiments of the present invention relate to an electrical connection unit.

Priority is claimed on Japanese Patent Application No. 2024-117486, filed on Jul. 23, 2024, the content of which is incorporated herein by reference.

### Description of Related Art

As an electrical connection unit, an electrical connection box as disclosed in Patent Document 1 is known.

### PRIOR ART DOCUMENT

### Patent Document

Patent Document 1: Japanese Unexamined Patent Application, First Publication No. 2012-191711

### SUMMARY OF THE INVENTION

In the electrical connection box disclosed in Patent Document 1, it is disclosed that the cover member is held in an open state by the locking claw on the cover side and the locking claw on the main body side.

However, in such an electrical connection unit, a space is required for providing the locking claw on the main body side so as to correspond to the locking claw on the cover side. This may make it difficult to reduce the space.

An embodiment provides an electrical connection unit that easily reduces the space.

An electrical connection unit according to an embodiment includes: an enclosure having a surface and an opening that is open on the surface; a rising structure that rises from the surface; and a cover capable of opening and closing the opening, wherein the enclosure includes a rib extending in an extending direction from the rising structure toward the opening, and the cover includes a protrusion pressed by the rib when the cover is opened.

According to an embodiment, the space is easily reduced.

### BRIEF DESCRIPTION OF THE DRAWINGS

FIG. 1 is a perspective view illustrating an electrical connection unit when a cover is closed according to an embodiment.

FIG. 2 is a plan view illustrating an enclosure of the embodiment.

FIG. 3 is a perspective view illustrating the electrical connection unit when the cover is opened according to the embodiment.

FIG. 4 is an enlarged view of a portion IV in FIG. 3.

FIG. 5 is a perspective view illustrating an electrical connection unit when a cover is closed according to a comparative example.

FIG. 6 is a perspective view illustrating the electrical connection unit when the cover is opened according to the comparative example.

FIG. 7 is an enlarged view of a portion VII in FIG. 6.

### DETAILED DESCRIPTION OF THE INVENTION

Hereinafter, an embodiment will be described with reference to the drawings. In the following description, components having the same or similar functions are denoted by the same reference number. Redundant descriptions of these components may be omitted. Note that the constitution described below does not limit the scope of the embodiment.

### Embodiment

### <1. Constitution of Electrical Connection Unit>

An electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box,” for example. However, the electrical connection unit 1 is not limited to a box-shaped device. The electrical connection unit 1 includes, for example, an enclosure 2, a rising structure 3, and a cover 4.

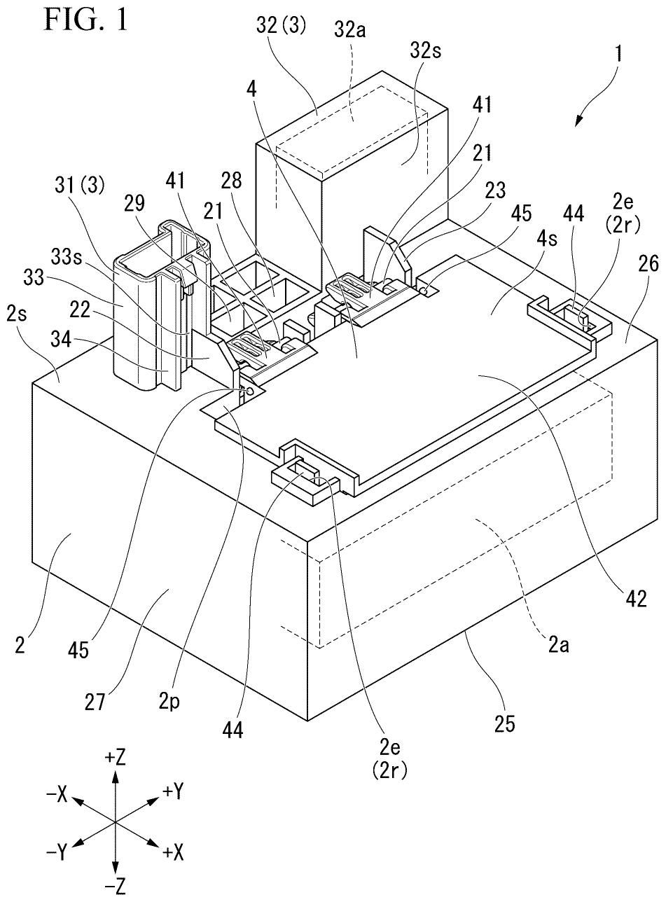

As illustrated in FIG. 1, the enclosure 2 has a surface 2s, an opening 2p, and a pair of recesses 2r. The opening 2p is open on the surface 2s.

The enclosure 2 includes a pair of shaft portions 21, a first rib 22, and a second rib 23. The first rib 22 is an example of a “rib”. The second rib 23 is an example of the “rib”. For example, the enclosure 2 may further include a recess structure 28.

The rising structure 3 includes a connector 31 and an extended accommodating portion 32.

The cover 4 is capable of opening and closing the opening 2p. The cover 4 includes a pair of bearing portions 41, a lid portion 42, a pair of locks 44, and a pair of protrusions 45.

In the present disclosure, the terms are defined as follows. “Parallel”, “orthogonal”, or “the same” may include “substantially parallel”, “substantially orthogonal”, or “substantially the same”, respectively. A “connection” is not limited to a mechanical connection, and may include an electrical connection. That is, the “connection” is not limited to a direct connection between two elements to be connected to each other, and may include a connection between two elements to be connected to each other with another element interposed therebetween. “Accommodating” is not limited to accommodating the entire part, and may include accommodating only a portion of a part (a state where the remaining portion of the part protrudes). “Covering” may include “covering a large portion while exposing a portion.”

In the present disclosure, a +X direction, a −X direction, a +Y direction, a −Y direction, a +Z direction, and a −Z direction are defined as follows.

The Y direction is a direction in which the pair of shaft portions 21 is arrayed in a plane along the surface 2s. The +Y direction is one direction of the Y direction. The −Y direction is a direction opposite to the +Y direction. Hereinafter, the +Y direction and the −Y direction are simply referred to as “Y direction” when they are not distinguished from each other. The Y direction is an example of an “axial direction” that is a direction in which an axial line of each shaft portion 21 extends. Note that the “axial direction” is not limited to the Y direction, and may be the X direction, the Z direction, or other directions.

The X direction is a direction intersecting (for example, orthogonal to) the Y direction in a plane along the surface 2s. The +X direction is one direction of the X direction. For example, the +X direction may be a direction in which the opening 2p is arrayed with respect to the rising structure 3 in the X direction. The −X direction is a direction opposite to the +X direction. Hereinafter, the +X direction and the −X direction are simply referred to as “X direction” when they are not distinguished from each other. The X direction is an example of an “extending direction” in which the first rib 22 and the second rib 23 each extend.

The Z direction is a direction intersecting (for example, orthogonal to) the X direction and the Y direction. For example, the Z direction may be a vertical direction. The +Z direction is one direction of the Z direction. For example, the +Z direction may be a direction in which the surface 2s faces. For example, the +Z direction may be an upward direction. The −Z direction is a direction opposite to the +Z direction. Hereinafter, the +Z direction and the −Z direction are simply referred to as “Z direction” when they are not distinguished from each other. Note that the “vertical direction” is not limited to the Z direction, and may be the X direction, the Y direction, or other directions.

Hereinafter, the +Z direction side may be referred to as “upper”, and the −Z direction side may be referred to as “lower”. However, these are expressions for convenience of description, and do not limit the gravity direction of the electrical connection unit 1 (installation posture of the electrical connection unit 1).

### <2. Constitution of Enclosure>

A detailed constitution of the enclosure 2 will be described.

The enclosure 2 is a main structure for accommodating the part. The enclosure 2 has a substantially rectangular parallelepiped outline as a whole. The enclosure 2 further includes a bottom plate 25, a top plate 26, and a peripheral wall 27. The enclosure 2 has a cavity 2a defined by the bottom plate 25, the top plate 26, and the peripheral wall 27. The top plate 26 has a surface facing the +Z direction side as the surface 2s. For example, the surface 2s may be a flat surface.

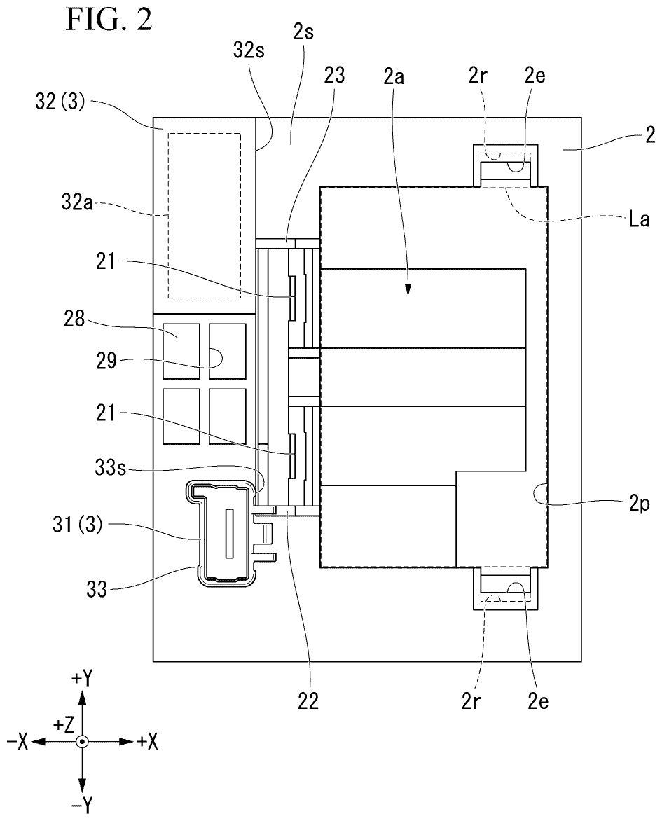

The opening 2p is connected to the cavity 2a, so that a user, an operator, or the like can replace the parts in the cavity 2a through the opening 2p. As illustrated in FIG. 2, the opening 2p is open along an imaginary line La having a rectangular outer peripheral shape when viewed from the Z direction.

The enclosure 2 has a recess 2r on each of both sides of the opening 2p in the Y direction. Each recess 2r is recessed in the Y direction from the imaginary line La toward an outside of the opening 2p with respect to an inner periphery of the opening 2p. Each recess 2r is recessed in the Y direction over a-Z direction length from the surface 2s. The inner peripheral surface defining the opening 2p and an inner peripheral surface of each recess 2r are continuous. An edge 2e of each recess 2r protrudes toward the opening 2p as compared with the other inner peripheral surface of each recess 2r facing the opening 2p.

As illustrated in FIGS. 1 and 2, the first rib 22 has a structure for supporting a posture of the connector 31 rising in the +Z direction. The first rib 22 protrudes from the surface 2s in the +Z direction. The first rib 22 extends in the +X direction toward the opening 2p continuously from the connector 31. For example, the first rib 22 may be a flat plate extending straight parallel to the X direction. For example, at least in a portion of the first rib 22, the protrusion height of the first rib 22 from the surface 2s may gradually decrease as the first rib 22 goes away from the connector 31.

The second rib 23 has a structure for supporting a posture of the extended accommodating portion 32 rising in the +Z direction. The second rib 23 protrudes from the surface 2s in the +Z direction. The second rib 23 extends in the +X direction toward the opening 2p continuously from the extended accommodating portion 32. For example, the second rib 23 may be a flat plate extending straight parallel to the X direction. For example, at least in a portion of the second rib 23, the protrusion height of the second rib 23 from the surface 2s may gradually decrease as the second rib 23 goes away from the extended accommodating portion 32.

The pair of shaft portions 21 is provided between the first rib 22 and the second rib 23. Each shaft portion 21 has an axial line extending in the Y direction. The pair of shaft portions 21 are separated from each other in the Y direction. The pair of shaft portions 21 are arrayed coaxially in the Y direction with their axial lines aligned with each other. Of the pair of shaft portions 21, the shaft portion 21 on the −Y direction side is continuous with the first rib 22 and extends in the +Y direction from the first rib 22. Of the pair of shaft portions 21, the shaft portion 21 on the −Y direction side when viewed from the Z direction is located on the −X direction side of the opening 2p and between the opening 2p and the connector 31. Of the pair of shaft portions 21, the shaft portion 21 on the +Y direction side is continuous with the second rib 23 and extends in the −Y direction from the second rib 23. Of the pair of shaft portions 21, the shaft portion 21 on the +Y direction side when viewed from the Z direction is located on the −X direction side of the opening 2p and between the opening 2p and the extended accommodating portion 32.

The recess structure 28 is located between the connector 31 and the extended accommodating portion 32 when viewed from the Z direction. The connector 31, the recess structure 28, and the extended accommodating portion 32 are arrayed in the Y direction when viewed from the Z direction. The recess structure 28 is recessed in the −Z direction from the surface 2s. The recess structure 28 includes a plurality of reinforcing ribs 29. Each reinforcing rib 29 extends in the +Z direction from a bottom of the recess structure 28 to a Z-direction position that is flush with the surface 2s. For example, the plurality of reinforcing ribs 29 may be combined in a lattice shape.

### <3. Constitution of Rising Structure>

A detailed constitution of the rising structure 3 will be described.

The connector 31 and the extended accommodating portion 32 are separated from each other in the Y direction.

The connector 31 can be connected to a wiring material-side connector to be connected to the electrical connection unit 1. When the connector 31 and the wiring material-side connector are connected to each other, a plurality of terminals of the connector 31 and a plurality of terminals of the wiring material-side connector are electrically connected to each other. For example, the connector 31 may include a housing 33 and an auxiliary rib 34.

The housing 33 rises so as to protrude from the surface 2s toward the +Z direction. The housing 33 has a tubular shape extending in the Z direction. A posture of the housing 33 rising in the Z direction is supported by the first rib 22. The housing 33 is continuous with the first rib 22. A side surface 33s of the housing 33 facing the +X direction is continuous with one end of the first rib 22 on the −X direction side.

The auxiliary rib 34 supports, separately from the first rib 22, the posture of the housing 33 rising in the Z direction. The auxiliary rib 34 protrudes from the housing 33 in the +X direction. The auxiliary rib 34 extends in the Z direction over the entire length of the housing 33 in the Z direction. The auxiliary rib 34 extends in the +X direction toward the opening 2p continuously from the side surface 33s.

The extended accommodating portion 32 accommodates a portion of the part accommodated in the enclosure 2. Specifically, the extended accommodating portion 32 has an extended cavity 32a that is connected to the cavity 2a and open toward the cavity 2a. The extended cavity 32a accommodates a portion of the part accommodated in the enclosure 2 that cannot be accommodated in the cavity 2a and protrudes from the cavity 2a. The extended accommodating portion 32 has a rectangular parallelepiped profile.

The extended accommodating portion 32 rises so as to protrude from the surface 2s toward the +Z direction. The extended accommodating portion 32 is continuous with the second rib 23. A side surface 32s of the extended accommodating portion 32 facing the +X direction is continuous with one end of the first rib 22 on the −X direction side.

The first rib 22, the second rib 23, and at least a part of the rising structure 3 are integrally molded to form an integrally molded part. For example, the surface 2s, the first rib 22, the second rib 23, the housing 33, and the extended accommodating portion 32 may be integrally molded with a resin material to form an integrally molded part.

### <4. Constitution of Cover>

A detailed constitution of the cover 4 will be described.

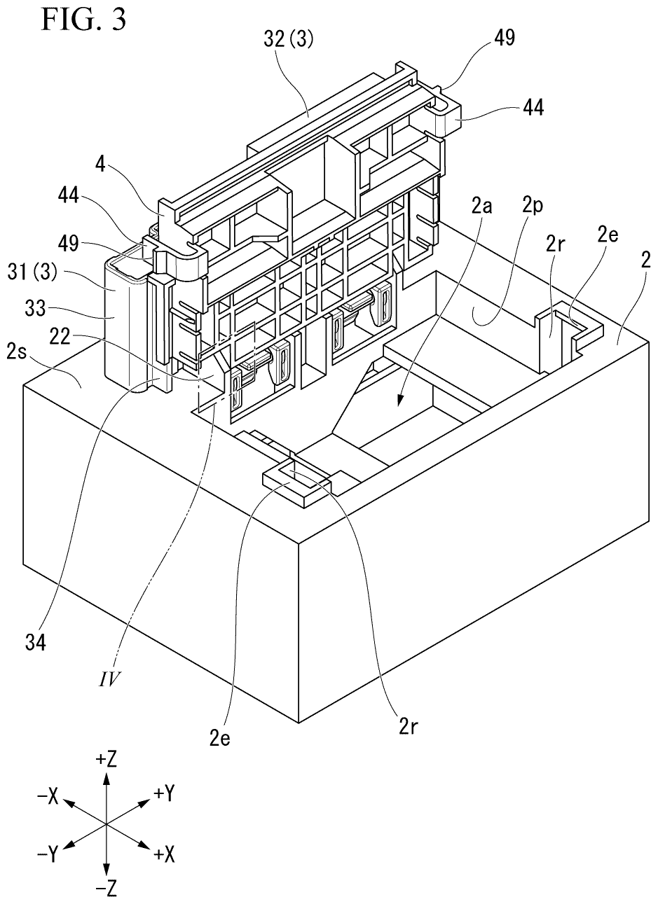

The lid portion 42 has a structure spreading in a planar shape. The lid portion 42 extends from the pair of bearing portions 41 so as to cover the opening 2p when the cover 4 closes the opening 2p (when the cover 4 is closed). The lid portion 42 covers the opening 2p by being fitted into the opening 2p from the +Z direction. The cover 4 has an outer surface 4s facing the +Z direction, which is the direction the surface 2s faces, when the cover 4 is closed. As illustrated in FIG. 3, the lid portion 42 extends in the +Z direction from each bearing portion 41 so as to expose the opening 2p when the cover 4 opens the opening 2p (when the cover 4 is opened). For example, the outer surface 4s may be a flat surface.

Each bearing portion 41 is fitted to the corresponding shaft portion 21 so as to be rotatable about the axial line of the corresponding shaft portion 21. That is, each bearing portion 41 and the corresponding shaft portion 21 constitute a hinge using the axial line of the shaft portion 21 as a rotation center. When the cover 4 is closed, each bearing portion 41 is fitted to the corresponding shaft portion 21 by extending so as to sandwich the corresponding shaft portion 21 from both sides in the Z direction when viewed from the Y direction. The pair of bearing portions 41 are arrayed apart from each other in the Y direction.

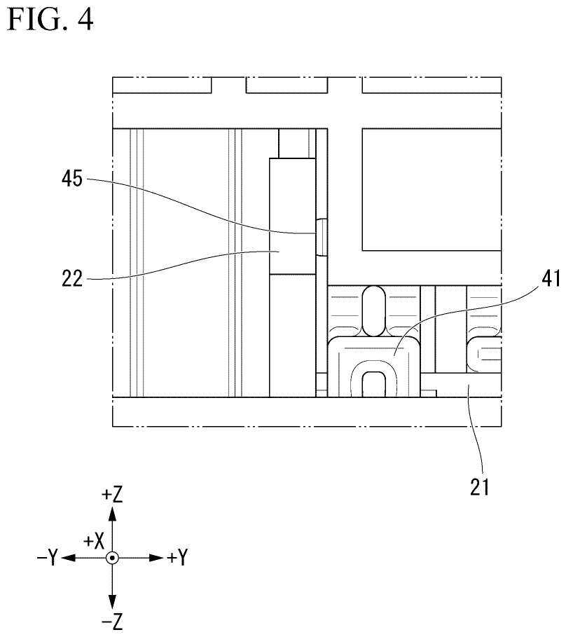

As illustrated in FIGS. 1 and 4, each protrusion 45 protrudes in the −Y direction from a surface of the corresponding bearing portion 41 facing the −Y direction. For example, each protrusion 45 may have a hemispherical shape centered on a rotational symmetry axis in the Y direction. For example, the surface of the bearing portion 41 facing the −Y direction may be a flat surface. When the cover 4 is opened, each protrusion 45 comes into contact with a flat surface facing the +Y direction of the corresponding rib, which is either the first rib 22 or the second rib 23. When the cover 4 is opened, each protrusion 45 is pressed by the flat surface facing the +Y direction of the corresponding rib, which is either the first rib 22 or the second rib 23. By this pressing, the pair of protrusions 45 temporarily hold the cover 4 in an open state.

Each lock 44 is fittable into the corresponding recess 2r. The pair of locks 44 are arrayed apart from each other in the Y direction. One lock 44 of the pair of locks 44 is provided outside the lid portion 42 in the +Y direction. The other lock 44 of the pair of locks 44 is provided outside the lid portion 42 in the −Y direction.

Each lock 44 holds the cover 4 in a closed state by being fitted into the corresponding recess 2r. For example, the pair of bearing portions 41, the lid portion 42, the pair of locks 44, and the pair of protrusions 45 may be integrally molded with a resin material to form an integrally molded part.

Each lock 44 has a claw portion 49 protruding in the Y direction and in a direction away from the lid portion 42. When the cover 4 is closed, the claw portion 49 gets over the edge 2e of the corresponding recess 2r on the +Z direction side and is caught by the edge 2e of the recess 2r from the −Z direction side, thereby causing the lock 44 to be engaged with the recess 2r. When the engaged lock 44 is deflected toward the lid portion 42 by an operation of the user, the operator, or the like, the claw portion 49 is disengaged from the edge 2e, and the engagement with the recess 2r is released.

### <5. Operation and Effects of the Invention>

According to the electrical connection unit 1 of the present embodiment, each protrusion 45 is pressed by the corresponding rib, which is either the first rib 22 or the second rib 23 extending from the rising structure 3. With such a constitution, it is possible to temporarily hold the cover 4 in the open state using the rib supporting the rising structure 3. If the rib supporting the rising structure 3 can be used for the temporary holding in the open state, a space for separately providing a rib for the temporary holding is no longer required. Therefore, the space is easily reduced.

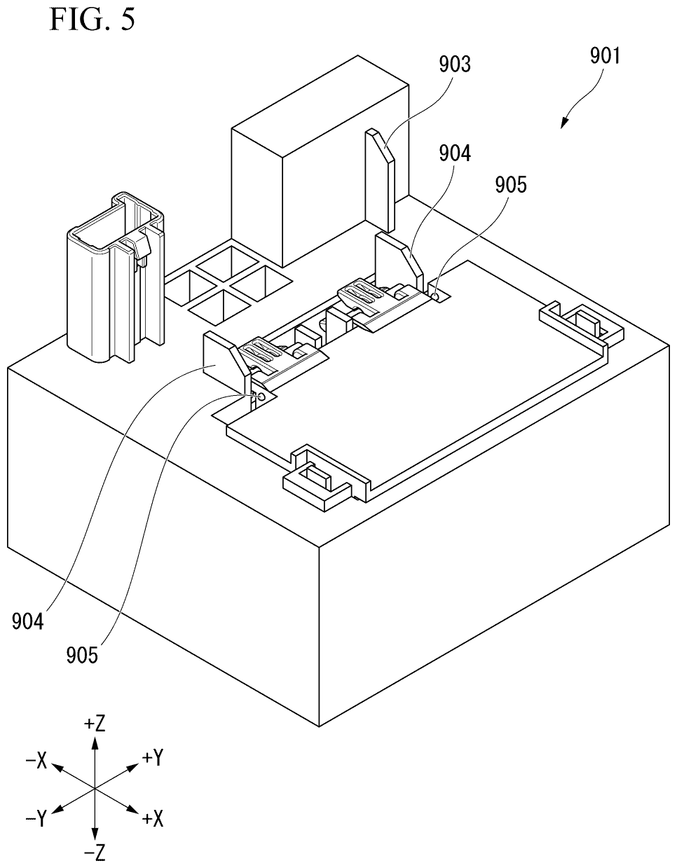

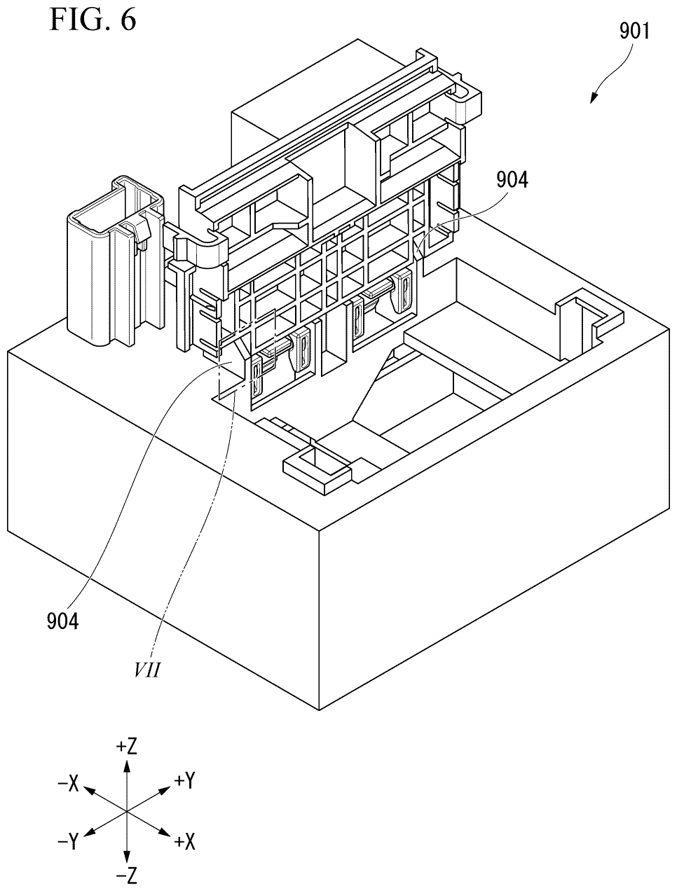

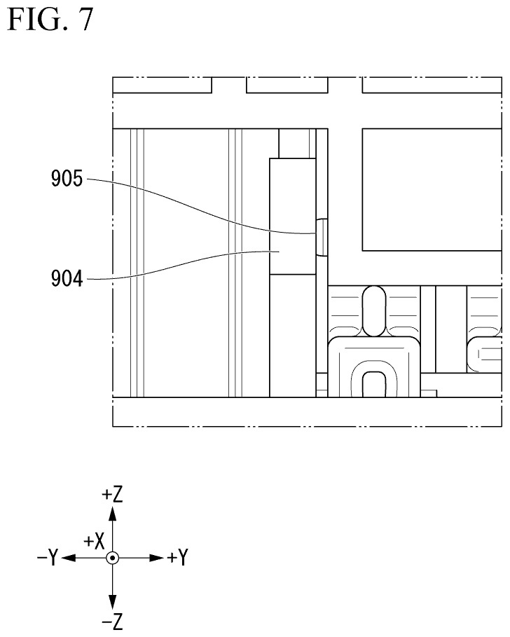

As a comparative example, an electrical connection unit 901 as illustrated in FIGS. 5 to 7 is conceivable. In the comparative example, when the cover is opened, a pressing rib 904 and a protrusion 905 of the cover are pressed to allow temporary holding. With such a constitution, the pressing rib 904 is required separately from a support rib 903 that supports the rising structure. When the pressing rib 904 is required, a mounting space and the amount of resin increase.

In contrast to the comparative example, the present embodiment does not require the pressing rib. Therefore, the space is easily reduced. Furthermore, the amount of resin can be reduced.

According to the electrical connection unit 1 of the present embodiment, the protrusion 45 protrudes in the Y direction from the bearing portion 41. With such a constitution, it is possible to provide the protrusion 45 for temporary holding in the space of the bearing portion 41. Therefore, the space is easily reduced.

According to the electrical connection unit 1 of the present embodiment, the first rib 22 extends from the connector 31. With such a constitution, it is possible to temporarily hold the cover 4 in the open state using the first rib 22 supporting the connector 31. If the first rib 22 can be used for the temporary holding in the open state, the space for separately providing the rib for the temporary holding is no longer required. Therefore, the space is easily reduced.

According to the electrical connection unit 1 of the present embodiment, the second rib 23 extends from the extended accommodating portion 32. With such a constitution, it is possible to temporarily hold the cover 4 in the open state using the second rib 23 supporting the extended accommodating portion 32. If the second rib 23 can be used for the temporary holding in the open state, the space for separately providing the rib for the temporary holding is no longer required. Therefore, the space is easily reduced.

The electrical connection unit 1 of the present embodiment includes the lock 44. With such a constitution, the cover 4 can be held in the closed state. Therefore, the cover 4 is easily maintained in the closed state.

According to the electrical connection unit 1 of the present embodiment, the first rib 22, the second rib 23, and at least a portion of the rising structure 3 form an integrally molded part. With such a constitution, it is possible to mold a portion of the component necessary for the temporary holding together with at least a portion of the rising structure 3.

### <6. Modification>

Next, several modifications will be described. Note that components other than those described below in each modification are the same as the components of the above-described embodiment.

### (First Modification)

In an example of the present embodiment, the surface 2s, the first rib 22, the second rib 23, and at least a portion of the rising structure 3 are integrally molded with a resin material. However, the electrical connection unit 1 may be constituted in any manner as long as the cover 4 can be temporarily held in the open state. As a modification, at least some components of the surface 2s, the first rib 22, the second rib 23, and the rising structure 3 may be separately molded with a resin material. As another modification, at least some components of the surface 2s, the first rib 22, the second rib 23, and the rising structure 3 may be integrally or separately molded with a metal material.

### (Second Modification)

In an example of the present embodiment, the pair of bearing portions 41, the lock 44, and the pair of protrusions 45 are integrally molded with a resin material. However, the electrical connection unit 1 may be constituted in any manner as long as the cover 4 can be temporarily held in the open state. As a modification, at least some components of the pair of bearing portions 41, the lock 44, and the pair of protrusions 45 may be separately molded with a resin material. As another modification, at least some components of the pair of bearing portions 41, the lock 44, and the pair of protrusions 45 may be integrally or separately molded with a metal material.

### (Third Modification)

In an example of the present embodiment, the first rib 22 for temporarily holding the cover 4 in the open state is a structure for supporting the connector 31. In addition, in an example of the present embodiment, the second rib 23 for temporarily holding the cover 4 in the open state is a structure for supporting the extended accommodating portion 32. However, the rib may be a structure for supporting any rising structure as long as the rib for supporting the rising structure can be used to temporarily hold the cover 4 in the open state. As a modification, the rib may be a structure for supporting a rising structure rising from the surface 2s such as a rod structure, a plate structure, and a solid block structure.

### (Fourth Modification)

In an example of the present embodiment, each rib of the first rib 22 and the second rib 23 extends straight in parallel to the X direction. However, each rib may extend in any manner as long as it can support the rising structure 3 and can be used to temporarily hold the cover 4 in the open state. As a modification, each rib may extend in the X direction in the XY plane while being bent in the Y direction. As another modification, each rib may extend in the X direction in the XY plane while being inclined in the Y direction.

The embodiment and the several modifications have been described above. However, the embodiment and the modifications are not limited to the examples described above. For example, a plurality of embodiments may be implemented in combination with each other. The embodiments described above can be implemented in various other forms, and various additions, omissions, substitutions, and other modifications can be made without departing from the scope of the present invention.

### INDUSTRIAL APPLICABILITY

According to an embodiment of the present disclosure, the space is easily reduced.

REFERENCE SIGNS LIST

| | |
|---|---|
| 1 | Electrical connection unit |
| 2 | Enclosure |
| 2a | Cavity |
| 2e | Edge |
| 2p | Opening |
| 2r | Recess |
| 2s | Surface |
| 3 | Rising structure |
| 4 | Cover |
| 4s | Outer surface |
| 21 | Shaft portion |
| 22 | First rib (Rib) |
| 23 | Second rib (Rib) |
| 25 | Bottom plate |
| 26 | Top plate |
| 27 | Peripheral wall |
| 28 | Recess structure |
| 29 | Reinforcing rib |
| 31 | Connector |
| 32 | Extended accommodating portion |
| 32a | Extended cavity |
| 32s | Side surface |
| 33 | Housing |
| 33s | Side surface |
| 34 | Auxiliary rib |
| 41 | Bearing portion |
| 42 | Lid portion |
| 44 | Lock |
| 45 | Protrusion |
| 49 | Claw portion |
| 901 | Electrical connection unit |
| 903 | Support rib |
| 904 | Pressing rib |
| 905 | Protrusion |
| La | Imaginary line |

What is claimed is:

1. An electrical connection unit comprising:
an enclosure having a surface and an opening that is open on the surface;
a rising structure that rises from the surface; and
a cover capable of opening and closing the opening,
wherein the enclosure includes a rib extending in an extending direction from the rising structure toward the opening, and
the cover includes a protrusion pressed by the rib when the cover is opened.

2. The electrical connection unit according to claim 1, wherein
the cover includes a bearing portion and a lid portion extending from the bearing portion so as to cover the opening when the cover is closed,
the enclosure includes a shaft portion that extends in an axial direction intersecting the extending direction and along the surface, the shaft portion being located between the lid portion and the rising structure when the cover is closed,
the bearing portion is fitted to the shaft portion so as to be rotatable about an axial line of the shaft portion, and
the protrusion protrudes from the bearing portion in the axial direction.

3. The electrical connection unit according to claim 1, wherein
the rising structure includes a connector, and
the rib extends from the connector toward the opening.

4. The electrical connection unit according to claim 1, wherein
the rising structure includes an extended accommodating portion that accommodates a portion of a part accommodated in the enclosure, and
the rib extends from the extended accommodating portion toward the opening.

5. The electrical connection unit according to claim 1, wherein
the enclosure has a recess on each of both sides of the opening in a direction intersecting the extending direction, and
the cover further includes a lock fittable into the recess.

6. The electrical connection unit according to claim 1, wherein
the rib and at least a portion of the rising structure form an integrally molded part.
